(19) United States
(12) Patent Application Publication
(10) Pub. No.: US 2025/0187087 A1
(43) Pub. Date: Jun. 12, 2025

(54) WORK MACHINE

(71) Applicant: KOKI HOLDINGS CO., LTD., Tokyo (JP)

(72) Inventors: Hiroyuki SAITOU, Ibaraki (JP); Masahide IMAYOSHI, Ibaraki (JP)

(73) Assignee: KOKI HOLDINGS CO., LTD., Tokyo (JP)

(21) Appl. No.: 18/842,511

(22) PCT Filed: Feb. 7, 2023
(86) PCT No.: PCT/JP2023/003916

§ 371 Date: Aug. 29, 2024

(30) Foreign Application Priority Data
Mar. 7, 2022 (JP) 2022-034814

(51) Int. Cl. B23D 45/14; B23D 47/04; B27B 5/29

(52) U.S. Cl. CPC B23D 45/14; B23D 47/042; B27B 5/29

(57) ABSTRACT

In a miter saw, a dust relief mechanism is provided in side fence portion of a fence on upper side of a base. The dust relief mechanism comprises a first relief groove portion penetrating in left-right direction at a lower end portion of a contact surface of the side fence portion, and a plurality of second relief groove portions penetrating in front-back direction at the lower end portion of the side fence portion. When pressing a material to be processed against the contact surface of the side fence portion, dust remaining between the side fence portion and the material to be processed can escape into the first and second relief groove portions. In turn, the dust can be prevented from intervening between the base and the material to be processed. Thus, it is not necessary for an operator to remove the dust on the base at each cutting process.

### BACKGROUND OF THE INVENTION

### Field of Invention

The present invention relates to a work machine.

### Description of Related Art

A miter saw (work machine) described in Patent Literature 1 below is provided with a fence on an upper surface of a base constituting a lower portion of the miter saw. In a cutting process, a material to be processed placed on the base is pressed against the fence to determine a position of the material to be processed relative to the base and the fence. In this state, a cutting portion is lowered to perform the cutting process on the material to be processed.

### RELATED ART LITERATURE

### Patent Literature

### [Patent Literature 1]

Japanese Unexamined Patent Application Publication No. 2017-64852.

### SUMMARY OF THE INVENTION

### Disclosure of Invention

### Problem to be Solved by Invention

During the cutting process by the miter saw, dust such as cutting chips is generated. At this time, the dust may remain on a placing surface of the base. In this state, when the material to be processed is pressed against the fence, the dust may enter between the material to be processed and the fence. In this case, positioning of the material to be processed with respect to the base and the fence becomes unstable. When cutting work is carried out in this state, the material to be processed may not be cut accurately, and workability of cutting is reduced. In addition, when an operator notices that the dust is interposed between the material to be processed and the fence, it is necessary to remove (clean) the dust on the material to be processed and the base. This may interrupt work and thus reduce the workability.

Considering the above facts, the present invention aims to provide the work machine capable of improving the workability.

### Means to Solve Problem

At least one embodiment of the present invention is a work machine comprising: a base on which a material to be processed is placed on an upper surface; a main body that is movably connected to the base and drives a blade for cutting the material to be processed; and a fence extending upward from the upper surface of the base, having a contact surface that restricts horizontal movement of the material to be processed placed on the upper surface of the base and a notch portion positioned under the contact surface.

At least one embodiment of the present invention is the work machine according to claim 1 comprising a discharge portion provided on the base and positioned on main body side from a contact range between the fence and the base, and moving dust on the upper surface downward from the upper surface.

At least one embodiment of the present invention is the work machine according to claim 1 or 2 wherein the contact surface is spaced apart from the upper surface.

At least one embodiment of the present invention is the work machine according to claim 1 wherein the base comprises: a base body to which the fence is fixed; and a turntable coupled rotatable to the base body with up-down direction as axis direction, wherein the notch portion is provided in an opposite portion to the base body of the fence.

At least one embodiment of the present invention is the work machine, wherein the fence extends in first direction parallel to the upper surface, wherein the notch portion is provided at least at one or other end portion in the first direction of the fence.

At least one embodiment of the present invention is the work machine, wherein the fence comprises: a main fence that is fixed to the base so as not to be relatively movable to the base; and a sub-fence connected to the main fence and relatively movable to the main fence, wherein the notch portion is provided at a lower end of the main fence.

At least one embodiment of the present invention is a work machine comprising: a base on which a material to be processed is placed on an upper surface; a main body that is movably connected to the base and drives a blade for cutting the material to be processed; a fence extending upward and in first direction on the upper surface of the base and having a contact surface that restricts movement of the material to be processed placed on the upper surface of the base to one side in second direction orthogonal to the first direction; and a dust relief mechanism for moving dust on the upper surface from the upper surface, wherein the dust relief mechanism has a notch portion under the contact surface in the fence to move the dust to said one side in the second direction relative to the contact surface.

At least one embodiment of the present invention is the work machine wherein the notch portion is at least partially positioned on said one side in the second direction relative to the contact surface.

At least one embodiment of the present invention is the work machine wherein the notch portion has a first relief groove portion formed under the contact surface, the first relief groove portion being in a groove shape and open to said one side and downward in the second direction.

At least one embodiment of the present invention is the work machine wherein the notch portion has a second relief groove portion, the second relief groove portion being in the groove shape or a hole shape penetrating the fence along the second direction.

At least one embodiment of the present invention is the work machine, wherein the notch portion comprises: a first relief groove portion being in a groove shape and formed under the contact surface and open to said one side and downward in the second direction; and a second relief groove portion formed at a lower end portion of the fence and penetrating along the second direction, wherein one-side end portion in the second direction of the second relief groove portion communicates with the first relief groove portion.

At least one embodiment of the present invention is the work machine wherein the upper surface of the second relief groove portion, in up-down direction, is positioned flush with or above the upper surface of the first relief groove portion.

At least one embodiment of the present invention is the work machine, wherein the base comprises: a base body to which the fence is fixed; and a turntable coupled rotatable to the base body with the up-down direction as axis direction, wherein the dust relief mechanism is disposed opposite the base body.

At least one embodiment of the present invention is the work machine wherein the notch portion or a discharge portion has a groove portion extending in the first direction, and the groove portion is open at least on said one side or other in the first direction.

### Advantage of Present Invention

According to at least one embodiment of the present invention, workability can be improved.

### BRIEF DESCRIPTION OF THE DRAWINGS

FIG. 1 is a perspective view from left oblique front illustrating a miter saw according to a first embodiment.

FIG. 2 is a side view from left side of the miter saw illustrated in FIG. 1.

FIG. 3 is a front view from front side illustrating a base and a left portion of a fence enlarged, illustrated in FIG. 1.

FIG. 4 is the perspective view of the fence enlarged illustrated in FIG. 1.

FIG. 5 is a bottom view from lower side of the fence illustrated in FIG. 4.

FIG. 6 is the perspective view from the lower side illustrating a side fence portion in the left side enlarged on the fence illustrated in FIG. 4.

FIG. 7 is a cross-sectional view (line 7-7 cross section in FIG. 3) from the left side illustrating a dust relief mechanism provided at a lower end portion of the side fence portion illustrated in FIG. 3.

FIG. 8 is a perspective view illustrating left periphery of a fence of a miter saw according to a second embodiment.

FIG. 9 is a plan view from upper side illustrating left periphery of the fence of the miter saw illustrated in FIG. 8.

FIG. 10 is a cross-sectional view from left side (line 10-10 cross section in FIG. 9) illustrating a dust relief mechanism provided on a base illustrated in FIG. 9.

### DETAILED DESCRIPTION OF THE INVENTION

### First Embodiment

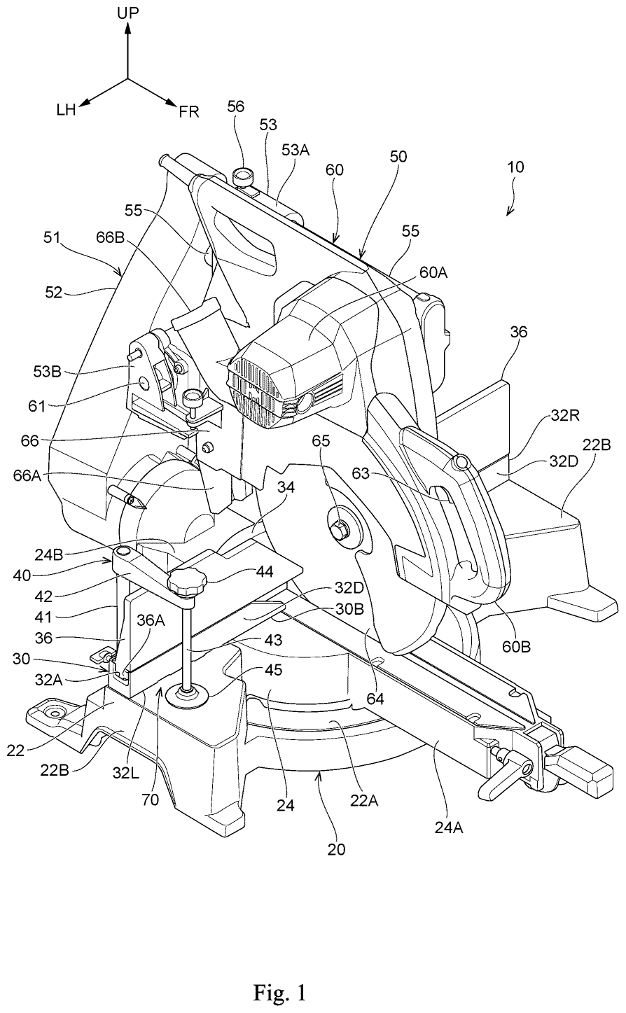

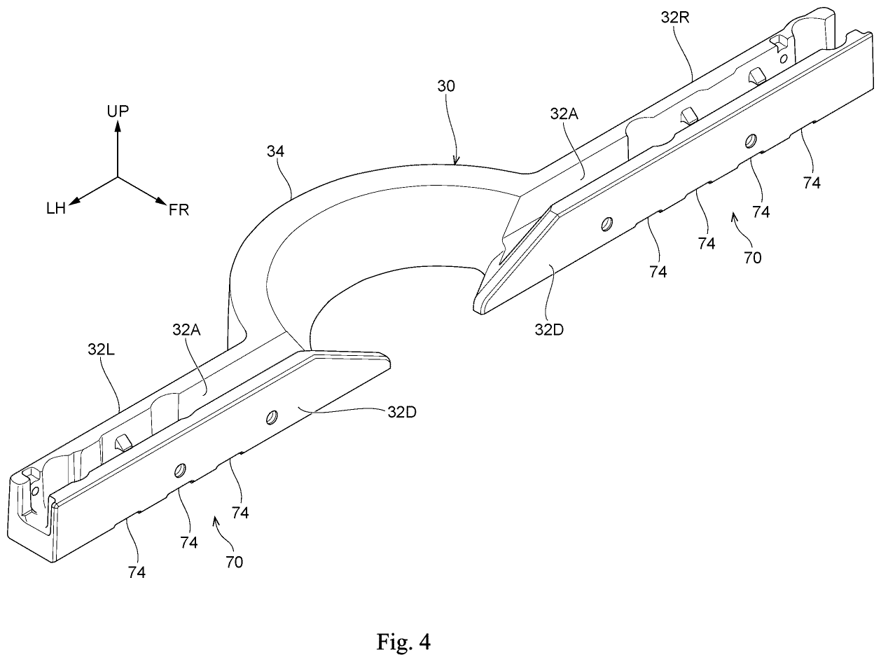

A miter saw 10 as a work machine according to a first embodiment will be described below, using FIG. 1 to FIG. 7. Arrows UP, FR, and LH illustrated in drawings as appropriate indicate upper, front, and left sides of the miter saw 10, respectively. In the following description, when directions up-down, front-back, and left-right are used, they will indicate vertical, front and back, and left and right directions of the miter saw 10, unless otherwise noted. The left-right direction corresponds to first direction of the present invention, and the front-back direction correspond to second direction of the present invention.

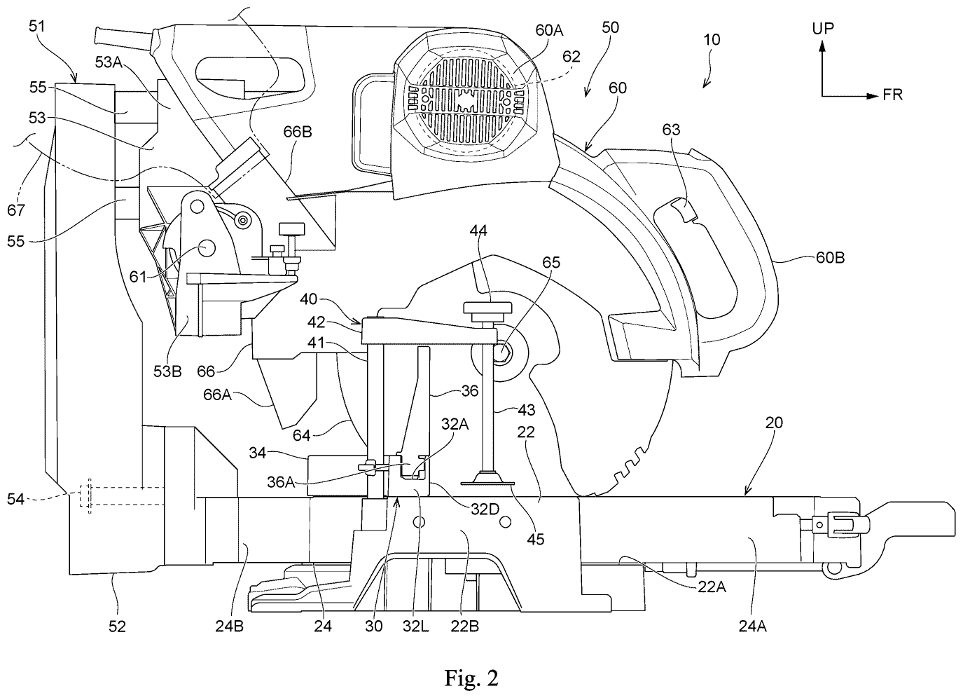

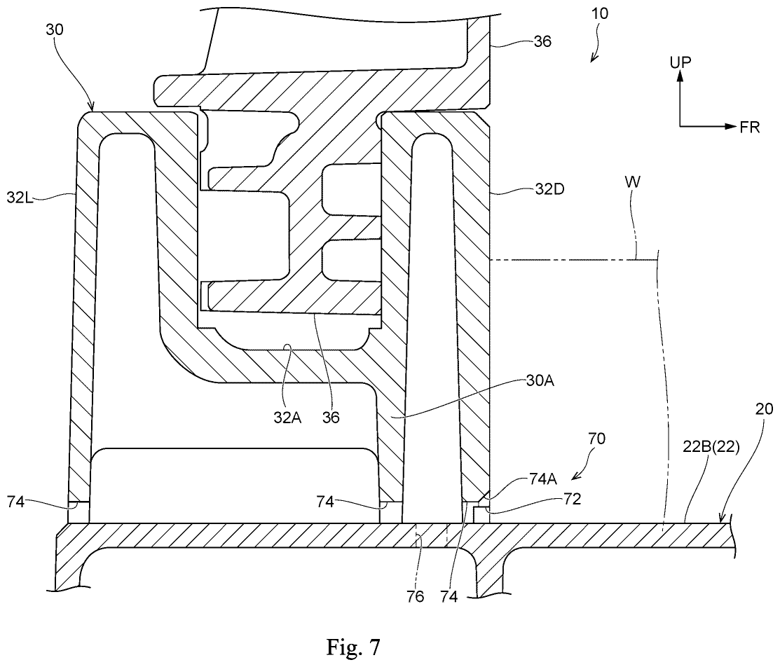

As illustrated in FIG. 1 and FIG. 2, the miter saw 10 is configured as a device for performing a cutting process on a material to be processed W (see FIG. 7). The miter saw 10 comprises a base 20 as a stand, a fence 30, a circular saw body 50 as a main body, and a dust relief mechanism 70.

### Base 20

The base 20 constitutes a lower end portion of the miter saw 10 and is configured as the stand on which the material to be processed W is placed. The base 20 has a base body 22 and a turntable 24. The base body 22 is formed in a substantially flat plate shape with the up-down direction as thickness direction. The base body 22 is formed in a concave shape open to lower side with a predetermined wall relief portion open to the lower side. A base recess 22A open to upper side is formed in a center portion in substantially left-right direction of the base body 22, and an outer portion in the left-right direction of the base recess 22A in the base body 22 is configured as a side base portion 22B.

The turntable 24 is disposed in the base recess 22A. The turntable 24 is formed in a substantially bottom cylindrical shape open to the lower side, and the center portion of the turntable 24 is rotatably supported by the base body 22 with the up-down direction as axis direction. An upper surface of the turntable 24 is disposed flush with the upper surface of the side base portion 22B. As a result, the direction of a cut surface of the material to be processed W during cutting can be changed by placing the material to be processed W on the upper surface of the turntable 24 and by rotating the turntable 24. The turntable 24 has a front table portion 24A protruding forwardly and a rear table portion 24B protruding rearwardly, which are formed in one piece.

### Fence 30

As illustrated in FIG. 1 to FIG. 7, the fence 30 extends in the left-right direction and is disposed above the base 20. During the cutting process for the material to be processed W, the material to be processed W is pressed against the fence 30 from front side to determine a position of the material to be processed W relative to the base 20 and fence 30 (see FIG. 7). The fence 30 comprises side fence portions 32L and 32R as fence portions comprising both side portions in left-right direction of the fence 30, and a center fence portion 34 coupling the side fence portions 32L and 32R. The side fence portions 32L and 32R are fixed to the base body 22 so that they cannot move relative to the base body 22.

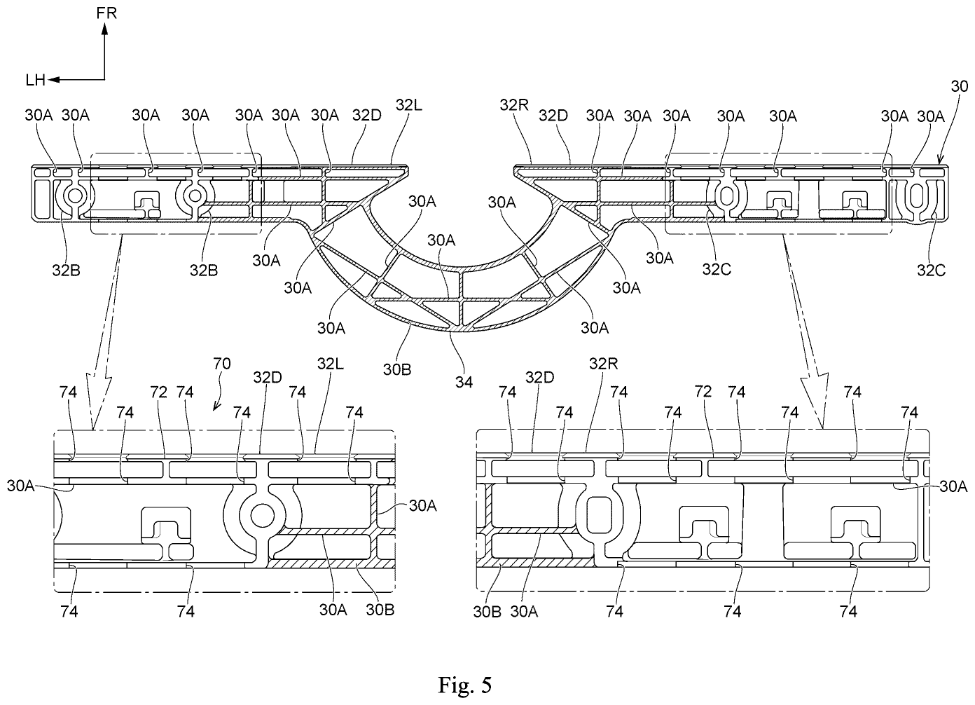

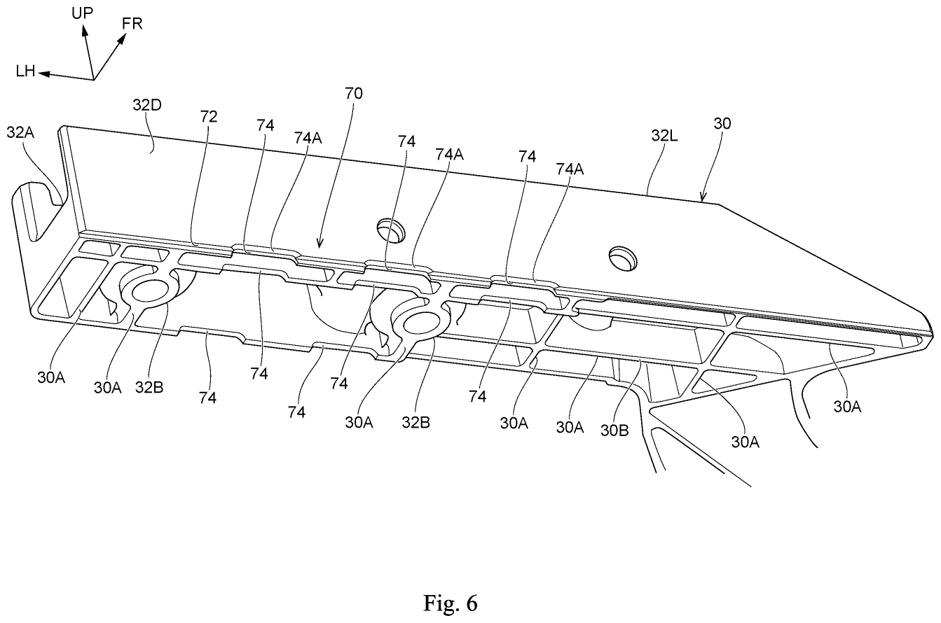

The side fence portions 32L and 32R are formed in the concave shape open to the upper side, viewed from the left-right direction. In other words, a fence groove portion 32A is formed in a middle portion in the front-back direction of the side fence portions 32L and 32R, and the fence groove portion 32A is open to the upper side and penetrates in the left-right direction. The length of the left-side fence portion 32L is slightly shorter than that of the right-side fence portion 32R. The side fence portion 32L has a plurality of (in the present embodiment, two points) fixing bosses 32B (see FIG. 5 and FIG. 6). The fixing bosses 32B are formed in a substantially stepped cylindrical shape with the up-down direction as axial direction and extend downward from a bottom wall of the fence groove portion 32A. The side fence portion 32R also has a plurality (in the present embodiment, two points) of fixing bosses 32C (see FIG. 5), which are formed in a substantially stepped elliptical cylindrical shape with the up-down direction as the axial direction and the front-back direction as longitudinal direction, and extend downward from the bottom wall of the fence groove portion 32A. The side fence portions 32L and 32R are fixed to the base body 22 by fixing bolts (not illustrated) inserted from the upper side into the fixing bosses 32B and 32C and screwed to the side base portion 22B.

Front surfaces of the side fence portions 32L and 32R are configured as contact surface 32D, and the contact surface 32D is disposed along a surface orthogonal to the front-back direction. It is configured so that during the cutting process, a rear surface of the material to be processed W placed on a front portion of the base 20 (a portion of the base 20 ahead of the fence 30) is pressed against the contact surface 32D to determine the position of the material to be processed W relative to the base 20 and the fence 30.

The upper surfaces of inner end portions in the left-right direction of the side fence portions 32L and 32R are, in front view from the front side, inclined downward as they move toward inner side (center in the left-right direction of the fence 30) in the left-right direction. This prevents interference between the circular saw body 50 and the side fence portions 32L, 32R when the circular saw body 50 is tilted as described below.

The center fence portion 34 is formed in a substantially semi-circular arc shape, open to the front side, in plan view from the upper side. The center fence portion 34 is disposed behind the side fence portions 32L and 32R, and both longitudinal end portions of the center fence portion 34 are connected to the inner end portions in the left-right direction of the side fence portions 32L and 32R. The front surface of the center fence portion 34 is inclined inwardly in radial direction of the center fence portion 34 as it moves downward, viewed from the longitudinal direction.

The fence 30 is configured with a metal material. The fence 30 is formed by casting. That is, inside of the fence 30 has the wall relief portion corresponding to an outer shape of the fence 30, and the fence 30 is formed in the concave shape open to the lower side. A plurality of reinforcing ribs 30A are formed inside the fence 30, and the reinforcing ribs 30A are formed in a substantially lattice shape viewed from the lower side.

Inner portions in the left-right direction of the side fence portions 32L and 32R and a lower surface of the center fence portion 34, including the reinforcing rib 30A, are configured as an offset surface 30B (see a hatched portion in FIG. 5). The offset surface 30B is disposed so as to be opposed to at least the turntable 24 in the up-down direction and is offset to the upper side with respect to the lower surface of the fence 30. As a result, the turntable 24 and the offset surface 30B are disposed so as to be opposed each other in the up-down direction with a predetermined gap, and the gap allows the turntable 24 to rotate.

A sub-fence 36 is provided on the upper side of the side fence portions 32L and 32R. The sub-fence 36 is formed in a substantially box shape with a relatively shallow bottom open to rear side. A rail portion 36A protruding downward is formed on a lower wall of the sub-fence 36, and the rail portion 36A is inserted into the fence groove portions 32A of the side fence portions 32L and 32R slidable in the left-right direction. The front surface of the sub-fence 36 is disposed flush with the contact surface 32D of the side fence portions 32L and 32R. The sub-fence 36 is configured to be movable relative to the base body 22 in the left-right direction by operating a fixing knob (not illustrated) to weaken the fixing force to the base body 22.

As illustrated in FIG. 1 to FIG. 3, the left side base portion 22B in the base body 22 mentioned above is provided with a vise device 40 for fixing the material to be processed W to the base body 22. The vise device 40 has a vise shaft 41 extending in the up-down direction at the rear side of the side fence portion 32L, and an arm 42 extending forward from an upper end portion of the vise shaft 41. The vise device 40 also has, a screw shaft 43 screwed to a front end portion of the arm 42 and extending in the up-down direction, a knob 44 provided at the upper end portion of the screw shaft 43, and a vise plate 45 provided at the lower end portion of the screw shaft 43. The material to be processed W is disposed under the vise plate 45, and the knob 44 is rotated to lower the screw shaft 43 and the vise plate 45, thereby pressing the material to be processed W downward by the vise plate 45 to fix it to the base 20.

### Circular Saw Body 50

As illustrated in FIG. 1 and FIG. 2, the circular saw body 50 comprises a hinge mechanism 51 and a head portion 60.

The hinge mechanism 51 has a first hinge 52 and a second hinge 53. The first hinge 52 is formed in a substantially long box shape that extends in the up-down direction and is open to the rear side. The first hinge 52 is disposed on the rear side of the rear table portion 24B in the turntable 24, and the lower end portion of the first hinge 52 is rotatably coupled to the rear table portion 24B by a first coupling shaft 54 with the front-back direction as the axis direction. As a result, the circular saw body 50 is configured to tilt to right or left with respect to the position illustrated in FIG. 1. The first hinge 52 has a long hole (not illustrated) extending in the circumferential direction of the first coupling shaft 54 in outer radial direction of the first coupling shaft 54. The fixing bolt is inserted into this long hole, and the fixing bolt is screwed into the rear table portion 24B to fix the first hinge 52 to the turntable 24. On the other hand, by releasing a fastening state of the fixing bolt, the first hinge 52 can be rotated around an axis of the first coupling shaft 54.

An upper portion of the first hinge 52 is inclined to the right as it moves upward, and the upper end portion of the first hinge 52 is positioned off to the right with respect to the lower end portion of the first hinge 52. A pair of upper and lower support shafts 55 are provided at the upper end portion of the first hinge 52. The support shaft 55 is disposed with the front-back direction as the axial direction and extends forward from the first hinge 52.

The second hinge 53 comprises a coupling portion 53A coupled to the support shaft 55 slidable in the front-back direction and a hinge portion 53B extending from the coupling portion 53A to left side. The coupling portion 53A is provided with a fixing screw 56 configured to be able to contact the support shaft 55, and movement of the second hinge 53 in the front-back direction is restricted by contacting a tip portion of the fixing screw 56 with the support shaft 55.

The head portion 60 is disposed on the front side of the hinge portion 53B of the second hinge 53, and a rear end portion of the head portion 60 is rotatably supported on the hinge portion 53B by a second coupling shaft 61 with the left-right direction as the axis direction. Specifically, the hinge portion 53B is formed in the concave shape that is open to the upper side when viewed from the front-back direction, and the rear end portion of the head portion 60 is inserted into the hinge portion 53B and the second coupling shaft 61 is crossed over the hinge portion 53B. The head portion 60 is held by a retention mechanism not illustrated. When viewed from the left side, by rotating the head portion 60 clockwise around the second coupling shaft 61 to a forward-tilted position illustrated in FIG. 1 and FIG. 2, the circular saw blade 64 described further below is inserted between the side fence portions 32L and 32R from the upper side to perform the cutting process on the material to be processed W on the base 20 by the circular saw blade 64.

A motor housing portion 60A protruding to the left side is formed at the upper end portion of the head portion 60, and a motor 62 is housed in the motor housing portion 60A. A handle portion 60B is formed at the front end portion of the head 60, and a trigger 63 is provided in the handle portion 60B operable to be pulled. A switch (not illustrated) is provided in the handle portion 60B, and the switch is configured to turn on when the trigger 63 is pulled. The switch and the motor 62 are electrically connected to a controller (not illustrated). As a result, the motor 62 is configured to be driven by the controller when the trigger 63 is pulled.

The head portion 60 has the circular saw blade 64 as a tip tool at the rear side of the handle portion 60B and under the motor housing 60A. The circular saw blade 64 is formed as a substantially circular plate shape with the left-right direction as the thickness direction. The center portion of the circular saw blade 64 is rotatably supported by a transmission mechanism 65 and the transmission mechanism 65 is configured to transmit driving force of the motor 62 to the circular saw blade 64. As a result, the circular saw blade 64 is rotated by driving the motor 62 to perform the cutting process to the material to be processed W.

The head portion 60 has a duct portion 66 integrally formed on the rear side of the circular saw blade 64. The duct portion 66 is formed in a cylindrical shape extending in substantially up-down direction. The lower end portion of the duct portion 66 is configured as a duct inlet portion 66A. The duct inlet portion 66A is formed in a substantially U-shape open to the front side (circular saw blade 64 side) in the plan view, and is disposed on the rear side to the center portion in the up-down direction of the circular saw blade 64. The upper end portion of the duct portion 66 is configured as a duct outlet portion 66B. The duct outlet portion 66B is formed in a substantially cylindrical shape and protrudes to upper oblique reward direction from the head portion 60. The upper end portion of the duct outlet portion 66B is configured so that a dust bag 67 (see FIG. 2) can be attached. During the cutting process, dust such as cutting chips scattered from the circular saw blade 64 to the rear side is inserted into the duct portion 66 from the duct inlet portion 66A and discharged from the duct outlet portion 66B into the dust bag 67. This causes the dust to be collected in the dust bag 67.

### Dust Relief Mechanisms 70

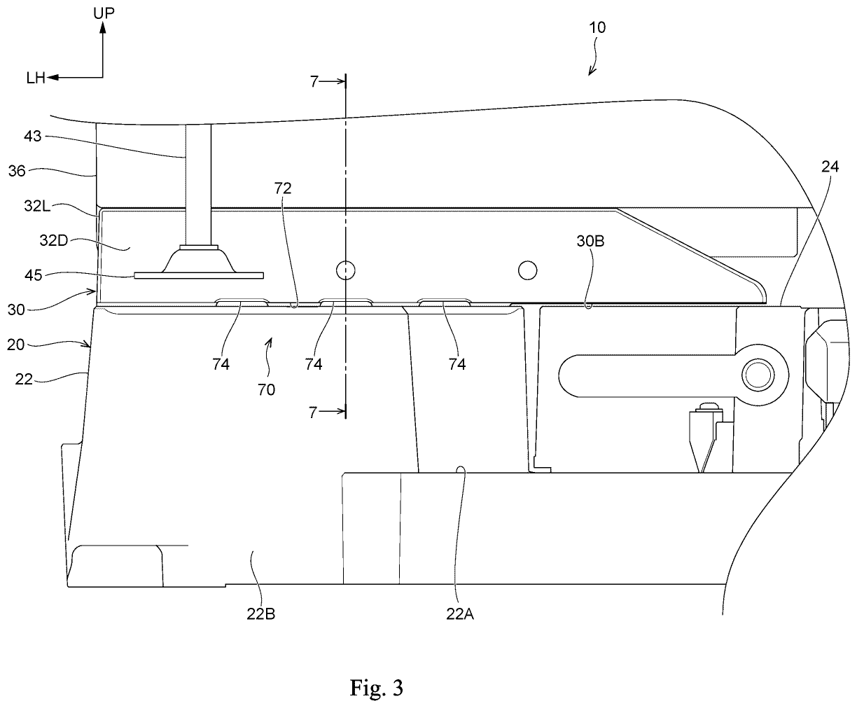

As illustrated in FIG. 1, FIG. 3 to FIG. 7, the dust relief mechanisms 70 are provided on the side fence portions 32L and 32R of the fence 30, respectively. The dust relief mechanism 70 provided on the side fence portion 32L and the dust relief mechanism 70 provided on the side fence portion 32R are symmetrically configured with respect to the center portion in the left-right direction of the miter saw 10, except for points shown below. For this reason, in the following description, the dust relief mechanism 70 provided on the side fence portion 32L will be described, and the description of the dust relief mechanism 70 provided on the side fence portion 32R will be omitted as appropriate.

The dust relief mechanism 70 is configured as a mechanism portion that releases the dust between the material to be processed W placed on the base 20 and the side fence portion 32L to the side fence portion 32L side and discharges the dust to both sides in the left-right direction of the side fence portion 32L and to the rear side of the side fence portion 32L. In the case of the present embodiment, the dust relief mechanism 70 is a notch formed at lower end of the side fence portions 32L and 32R (under the contact surface 32D). The dust relief mechanism 70 (notch portion) is provided at the lower end portion of the side fence portion 32L and comprises a first relief groove portion 72 and a plurality (in the present embodiment, at three points) of second relief groove portions 74. The dust relief mechanism 70 provided in the side fence portion 32R comprises the first relief groove portion 72 and the second relief groove portions 74 at four points.

The first relief groove portion 72 is formed at the lower end portion of the contact surface 32D of the side fence portion 32L. The first relief groove portion 72 penetrates along the left-right direction and is formed in a stepped shape open to the lower side and the front side when viewed from the left-right direction. In the present embodiment, a dimension in the up-down direction of the first relief groove portion 72 is set so that the relatively thin plate-like material to be processed W does not fit into the first relief groove portion 72. As an example, the dimension in the up-down direction of the first relief groove portion 72 is set to 1.5 mm.

The second relief groove portion 74 is formed at the lower end portion of the side fence portion 32L. The second relief groove portion 74 penetrates along the front-back direction and is formed in a groove shape open to the lower side in the front view. In other words, the second relief groove portion 74 is formed on outer circumferential walls (front and rear walls) of the side fence portions 32L and 32R and the lower end portion of the reinforcing rib 30A, and penetrates in the front-back direction. As a result, the front end portion of the second relief groove portion 74 is made to communicate to the first relief groove portion 72. In the second relief groove portion 74, which is disposed most inwardly in the left-right direction, the offset surface 30B is formed instead of the second relief groove portion 74 in the rear wall of the side fence portion 32L.

A width dimension (left-right dimension) of the second relief groove portion 74 is set significantly larger than groove depth (up-down dimension) of the second relief groove portion 74. The groove depth of the second relief groove portion 74 is set larger than the groove depth (up-down dimension) of the first relief groove portion 72 and is set to match offset distance from the lower surface of the fence 30 at the offset surface 30B. In other words, the upper surface of the second relief groove portion 74 and the offset surface 30B are disposed above the upper surface of the first relief groove portion 72.

A chamfer portion 74A (see FIG. 7) is formed at a front opening edge portion of the second relief groove portion 74. Furthermore, the plurality of second relief groove portions 74 are arranged side by side with a predetermined spacing in the left-right direction.

### Action and Effect

The action and effect of the present embodiment will be described.

In the cutting process of the miter saw 10 configured as described above, the material to be processed W is placed on the base 20 at the front side of the fence 30. Then, the material to be processed W is moved to the rear side and the rear surface of the material to be processed W is pressed against the contact surface 32D of the side fence portions 32L and 32R. This determines the position of the material to be processed W with respect to the base 20 and the side fence portions 32L, 32R. In this state, by operating the knob 44 of the vise device 40, the material to be processed W is pressed from the upper side by the vise plate 45 to fix the material to be processed W to the base 20. Then, an operator grasps the handle portion 60B and tilts the head portion 60 forward to perform the cutting process on the material to be processed W by the circular saw blade 64.

At this time, the dust such as the cutting chips generated during the cutting process is rolled up to the rear side by the circular saw blade 64 and inserted into the duct portion 66 from the duct inlet portion 66A and discharged into the dust bag 67 from the duct outlet portion 66B. This causes the dust to be collected in the dust bag 67.

The dust generated during the cutting process may be collected in the dust bag 67 as in the present embodiment to prevent scattering, but the dust that is not collected in the dust bag 67, for example, may remain on the base 20 or on the material to be processed W. As the cutting process is repeated, the remaining dust is accumulated on the base 20 (between the material to be processed W and the side fence portions 32L, 32R). Then, by moving the material to be processed W for positioning after each cutting process, the dust on the base 20 is pushed by the material to be processed W toward the side fence portions 32L and 32R, and enters and accumulates between the side fences portions 32L and 32R and the material to be processed W. The accumulated dust prevents the material to be processed W from being pressed against the side fence portions 32L and 32R without gaps, and the position of the material to be processed W with respect to the base 20 and fence 30 changes. As a result, when performing the cutting process on the material to be processed W in this state, an angle of the cut surface formed on the material to be processed W (angle viewed from the front-back direction, angle viewed from the upper side and so on) may deviate from a setting angle, and processing accuracy for the material to be processed W may be reduced. Therefore, in order to suppress decrease in the processing accuracy, the operator needs to remove the dust on the base 20 (between the side fence portions 32L and 32R and the material to be processed W, and between the base 20 and the material to be processed W). As a result, workability during the cutting process may deteriorate.

Here, the side fence portions 32L and 32R of the fence 30 on the upper side of the base 20 are provided with the dust relief mechanism 70. The dust relief mechanism 70 comprises the first relief groove portion 72 and the plurality of second relief groove portions 74. The first relief groove portion 72 is formed at the lower end portion of the contact surface 32D of the side fence portions 32L and 32R and penetrates in the left-right direction. The second relief groove portion 74 also penetrates in the front-back direction at the lower end portion of the side fence portions 32L, 32R. Therefore, when the material to be processed W is pressed against the contact surface 32D of the side fence portions 32L, 32R, the dust remaining on the base 20 (between the side fence portions 32L, 32R and the material to be processed W) can be pushed into the first and second relief groove portions 72, 74 by moving the material to be processed W for positioning. This allows the dust on the base 20 (between the side fence portions 32L, 32R and the material to be processed W) to release into the first and second relief groove portions 72, 74, thereby preventing the dust from intervening between the material to be processed W and the contact surface 32D of the side fence portions 32L, 32R, and between the base 20 and the material to be processed W. In other words, the dust remaining on the base 20 (between the side fence portions 32L, 32R and the material to be processed W) is released into the first relief groove portion 72 and the second relief groove portion 74 after each cutting process of the material to be processed W, thereby preventing the dust from accumulating on the base 20 (between the side fence portions 32L, 32R and the material to be processed W). This in turn prevents the state where the dust remains (intervenes) from being maintained between the base 20 and the material to be processed W. As a result, the position of the material to be processed W with respect to the side fence portions 32L, 32R and the base 20 can be properly determined, and the cutting process can be performed on the material to be processed W.

The first relief groove portion 72 penetrates in the left-right direction. In other words, the left end portion of the first relief groove portion 72 is open to the left and the right end portion is open to the right. Therefore, the dust that escapes into the first relief groove portion 72 can be discharged from both end portions in the left-right direction of the first relief groove portion 72 to outside in the left-right direction. The first relief groove portion 72 may be configured so that either end portion is open in the left-right direction. The second relief groove portion 74 penetrates in the front-back direction. Therefore, the dust that escapes into the second relief groove portion 74 can be discharged from the rear end portion of the second relief groove portion 74 to the rear side of the side fence portions 32L and 32R. During operation by the miter saw 10, vibration caused by driving the motor 62 is transmitted to the base 20, and the miter saw 10 (i.e., the base 20) vibrates. As a result, the vibration causes the dust to move within the first relief groove portion 72 and to be discharged from the both end portions in the left-right direction of the first relief groove portion 72. That is, in the present embodiment, for the dust that has moved into the first relief groove portion 72 or second relief groove portion 74, further movement is promoted by driving of the motor 62 and the dust can be moved to the outside of the base 20. The dust moves within the second relief groove portion 74 and is discharged from the rear end portion of the second relief groove portion 74. As described above, the miter saw 10 according to the present embodiment reduces requirement for the operator to remove the dust on the base 20 (between the side fence portions 32L, 32R and the material to be processed W, and between the base 20 and the material to be processed W) after each cutting process. Thus, the workability for the operator can be improved.

The dust relief mechanism 70 is provided at the lower end portions of the side fence portions 32L and 32R. In other words, the dust relief mechanism 70 is disposed on the rear side (opposite side of the material to be processed W) with respect to the contact surface 32D with which the material to be processed W is in contact. As a result, the dust relief mechanism 70 can be provided on the miter saw 10 while preventing the dust relief mechanism 70 from being disposed in a working area of the base 20 (an area on which the material to be processed W is placed and the area ahead of the side fence portions 32L and 32R). Therefore, influence on the workability by providing the dust relief mechanism 70 can be suppressed.

The upper surface of the second relief groove portion 74 is disposed above the upper surface of the first relief groove portion 72. In other words, the dimension in the up-down direction of the second relief groove portion 74 is set larger than the dimension in the up-down direction of the first relief groove portion 72. This allows, for example, the dust on the base 20, especially between the side fence portions 32L and 32R and the material to be processed W, to be pushed (moved) into the first relief groove portions 72 and second relief groove portions 74, while preventing the relatively thin plate like material to be processed W from fitting into the first relief groove portion 72. The dust pushed into the second relief groove portion 74 by the material to be processed W can be efficiently discharged from the second relief groove portion 74 to the rear side of the side fence portions 32L, 32R.

In the first embodiment, the upper surface of the second relief groove portion 74 is disposed above the upper surface of the first relief groove portion 72, but an up-down position of the upper surface of the second relief groove portion 74 may be set so that it is disposed flush with the upper surface of the first relief groove portion 72.

### Second Embodiment

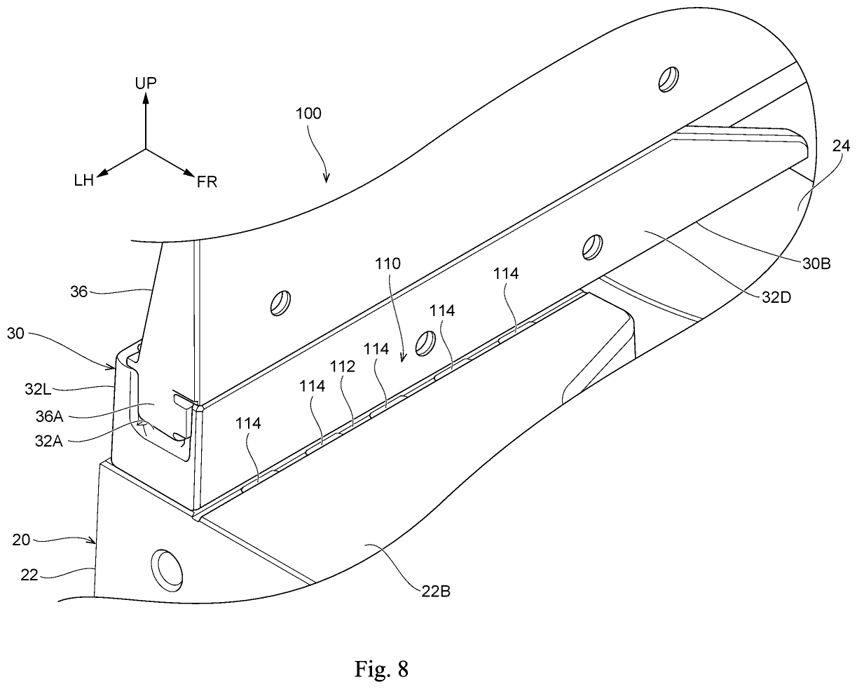

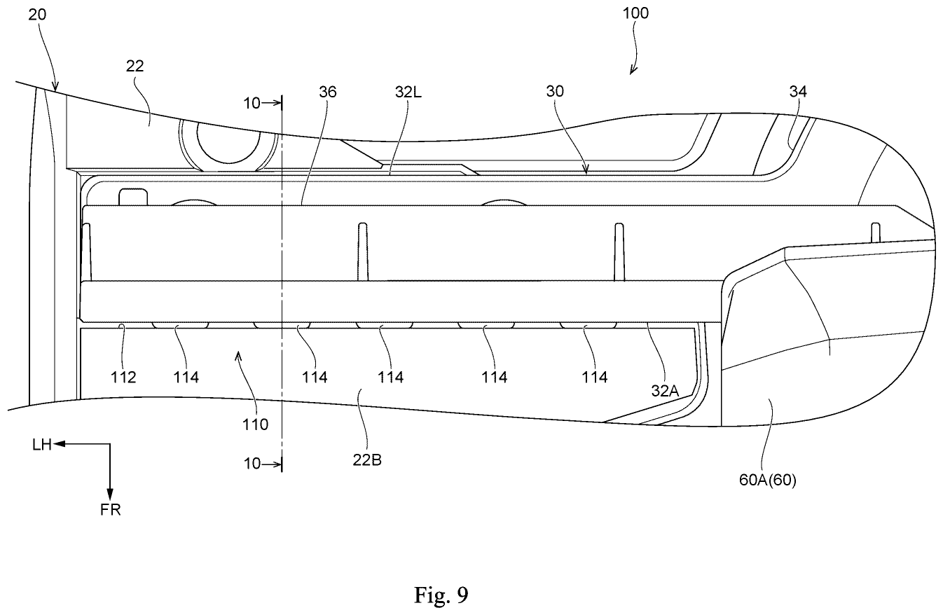

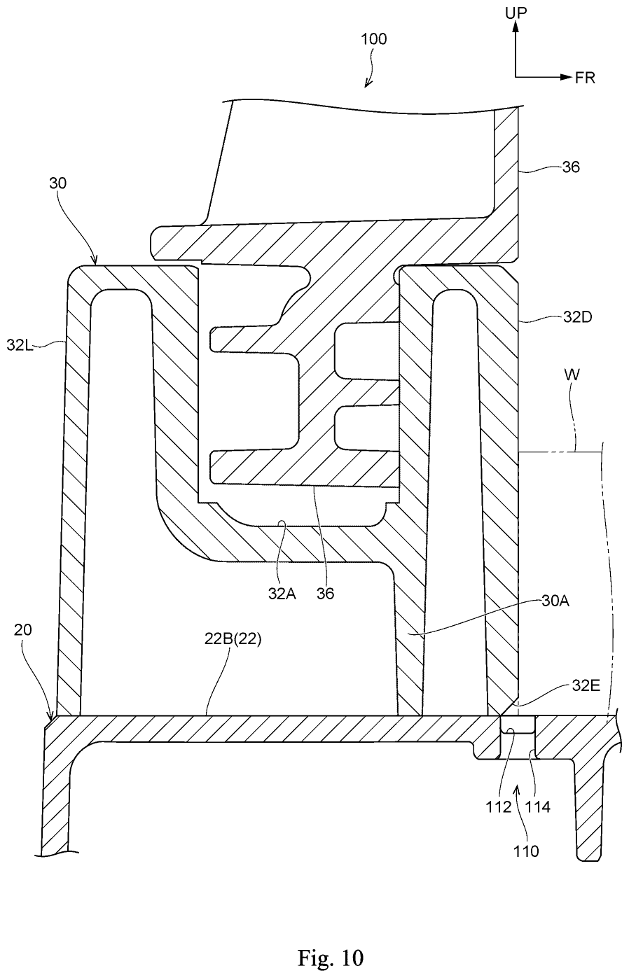

A miter saw 100 as a work machine according to a second embodiment will be described using FIG. 8 to FIG. 10. The miter saw 100 of the second embodiment is configured in the same manner as the miter saw 10 of a first embodiment, except for points shown below. In FIG. 8 to FIG. 10, portions similarly configured to the miter saw 10 of the first embodiment are marked with the same symbols.

In the second embodiment, a dust relief mechanism 70 is omitted from a fence 30, and a dust relief mechanism 110 (discharge portion) is provided in a base body 22 of a base 20. The dust relief mechanism 110 (discharge portion) is provided on left and right side base portions 22B of the base body 22, respectively. The dust relief mechanism 110 provided on the left side base portion 22B and the dust relief mechanism 110 provided on the right side base portion 22B are symmetrically configured with respect to center portion in left-right direction of the miter saw 100, except for the points shown below. For this reason, in the following description, the dust relief mechanism 110 provided on the left side base 22B will be described, and the description of the dust relief mechanism 110 provided on the right side base 22B will be omitted as appropriate.

The dust relief mechanism 110 comprises a first relief groove portion 112 and a plurality (in the present embodiment, five points) of second relief groove portions 114. The dust relief mechanism 110 on the right side base 22B comprises the first relief groove portion 112 and the second relief groove portions 114 at seven points.

The first relief groove portion 112 is formed on an upper surface of the side base portion 22B. The first relief groove portion 112 is formed in a groove shape open to upper side and extending along the left-right direction, and penetrating in the left-right direction. The first relief groove portion 112 is positioned on front side of side fence portion 32L such that, in plan view, a contact surface 32D of the side fence portion 32L is positioned within a middle portion in front-back direction of the first relief groove portion 112. That is, when viewed from the left-right direction, the side fence portion 32L (a lower end portion of the side fence portion 32L) protrudes forward relative to a rear surface of the first relief groove portion 112. In other words, the contact surface 32D is positioned forward of the rear surface of the first relief groove portion 112. A guide portion 32E is formed at the lower end portion of the contact surface 32D of the side fence portion 32L. The guide portion 32E is configured as an inclined surface that inclines toward the front side as it moves upward. In the front-back direction, a lower end position of the guide portion 32E is aligned with a rear surface position of the first relief groove portion 112, but they are not necessarily aligned. At least a portion of the first relief groove portion 112 (dust relief mechanism 110) is positioned forward (on circular saw body 50 side) of a contact range (attachment point) between the side fence portion 32L and the side base portion 22B.

The second relief groove portion 114 is formed on a bottom surface of the first relief groove portion 112 and penetrates in up-down direction. The second relief groove portion 114 is formed in a long hole shape (slit shape) with the left-right direction as longitudinal direction, and a dimension of the first relief groove portion 112 and the dimension of the second relief groove portion 114 in the front-back direction match. The plurality of second relief groove portions 114 are arranged side by side with a predetermined spacing in the left-right direction The second relief groove portion 114 is, at least partially, positioned forward (on the circular saw body 50 side) of the contact range (attachment point) between the side fence portion 32L and the side base portion 22B.

During the cutting process, when a material to be processed W is pressed against the contact surface 32D of the side fence portions 32L and 32R from the front side, dust remaining on the base 20, especially between the side fence portions 32L and 32R and the material to be processed W, moves to rear side by moving the material to be processed W for positioning and falls into the first relief groove portion 112 and the second relief groove portion 114. In other words, the dust moves to the dust relief mechanism (first relief groove portion 112 and second relief groove portion 114) by an act of pressing the material to be processed W against the contact surface 32D. The dust falling into the second relief groove portion 114 falls through the second relief groove portion 114 and is discharged to lower side of the base 20. As a result, also in the second embodiment, the dust remaining on the base 20 (between the side fence portions 32L and 32R and the material to be processed W) is released into the first relief groove portion 112 and the second relief groove portion 114 after each cutting process for the material to be processed W, thereby preventing the dust from accumulating on the base 20. Therefore, during the cutting process, the dust can be suppressed from intervening between the side fence portions 32L and 32R and the material to be processed W, and between the base 20 and the material to be processed W. Also in the second embodiment, vibration generated when a motor 62 is driven causes the dust to move within the first relief groove portion 112 and be discharged from both end portions in the left-right direction of the first relief groove portion 112 and the second relief groove portion 114. Therefore, in the second embodiment, as in the first embodiment, workability for an operator can be improved.

In the second embodiment, the first relief groove portion 112 is positioned adjacent to the front side of the side fence portions 32L and 32R in the plan view. This allows the dust to move to the rear side when the material to be processed W is moved for positioning, and the dust that has moved to the rear side can fall into the first relief groove portion 112. At this time, the dust is blocked by the side fence portions 32L and 32R, which improves certainty that the dust will fall into the first relief groove portion 112.

In the second embodiment, the contact surface 32D (lower end portion) of the side fence portions 32L, 32R is positioned ahead of (protruded forward) the rear surface of the first relief groove portion 112 and is positioned above the rear end portion of an opening portion in the first relief groove portion 112. Furthermore, the guide portion 32E is formed at the lower end portion of the contact surface 32D of the side fence portions 32L and 32R. The guide portion 32E is configured as the inclined surface that inclines toward the front side as it moves upward when viewed from the left-right direction. As a result, when the side fence portions 32L and 32R block the dust moving to the rear side, the direction of the dust is changed to the lower side by the guide portion 32E, allowing the dust to properly fall down into the first relief groove portion 112.

In the first embodiment, the dust relief mechanism 70 comprises the first relief groove portion 72 and the plurality of second relief groove portions 74, but one of the first relief groove portion 72 and the second relief groove portion 74 may be omitted. In this case, the dust remaining on the base 20 can still escape into the first relief groove portion 112 or the second relief groove portion 114 to prevent the dust from being interposed between the material to be processed W and the side fence portions 32L, 32R. Similarly in the dust relief mechanism 110 of the second embodiment, one of the first relief groove portion 112 and the second relief groove portion 114 may be omitted.

Features of the first and second embodiments can be combined as appropriate, that is, the dust relief mechanism 70 (110) can be configured to be provided in the fence 30 and the base 20. For example, as illustrated by two-pointed line in FIG. 7, a third relief groove portion 76 with the left-right direction as the longitudinal direction may be formed through the side base 22B, and the third relief groove portion 76 may be disposed to overlap the second relief groove portion 74. In the present invention, the dust relief mechanism may be provided on only one of the fence 30 and base 20, or on both. In other words, only one of the notch portions in the fence 30 and the discharge portion in the base 20 may be implemented, or both may be implemented. In the second embodiment, some portions of the first relief groove portion 112 and the second relief groove portion 114 are positioned in an area behind the contact surface 32D, but all of them may be positioned in front of the contact surface 32D.

### DESCRIPTION OF REFERENCE NUMERALS

10: Miter saw (work machine)
20: Base (stand)
22: Base body
24: Turntable
32L: Side fence portion (fence portion)
32R: Side fence portion (fence portion)
32D: Contact surface
50: Circular saw body (main body)
70: Dust relief mechanism (notch portion)
72: First relief groove portion
74: Second relief groove portion
100: Miter saw (work machine)
110: Dust relief mechanism (discharge portion)

1. A work machine comprising:
a base on which a material to be processed is placed on an upper surface;
a main body that is movably connected to the base and drives a blade for cutting the material to be processed; and
a fence extending upward from the upper surface of the base,
wherein the fence has a contact surface that is positioned above the upper surface and restricts horizontal movement of the material to be processed placed on the upper surface of the base and a notch portion that is provided at a lower end of the fence and is positioned under the contact surface and above the upper surface.

2. The work machine according to claim 1 comprising:
a discharge portion provided on the base and positioned on main body side from a contact range between the fence and the base, and moving dust on the upper surface downward from the upper surface,
wherein a space generated by the notch portion is positioned above the upper surface and behind the contact surface, and the space communicates with the discharge portion.

3. The work machine according to claim 1 configured to be able to discharge the dust on the upper surface to outside in left-right direction of the upper surface through the notch portion and/or to the behind of the upper surface and the contact surface through the notch portion.

4. The work machine according to claim 1,
wherein the base comprises:
a base body to which the fence is fixed; and
a turntable coupled rotatable to the base body with up-down direction as axis direction,
wherein the notch portion is provided in an opposite portion to the base body of the fence.

5. The work machine according to claim 4,
wherein the fence extends in first direction parallel to the upper surface,
wherein the notch portion is provided at least at one or other end portion in the first direction of the fence.

6. The work machine according to claim 1,
wherein the fence comprises:
a main fence that is fixed to the base so as not to be relatively movable to the base; and
a sub-fence connected to the main fence and relatively movable to the main fence,
wherein the notch portion is provided at a lower end of the main fence.

7. A work machine comprising:
a base on which a material to be processed is placed on an upper surface;
a main body that is movably connected to the base and drives a blade for cutting the material to be processed;
a fence extending upward and in first direction on the upper surface of the base and having a contact surface that restricts movement of the material to be processed placed on the upper surface of the base to one side in second direction orthogonal to the first direction; and
a dust relief mechanism for moving dust on the upper surface from the upper surface,
wherein the dust relief mechanism has a notch portion under the contact surface in the fence to move the dust to said one side in the second direction relative to the contact surface.

8. The work machine according to claim 7 wherein the notch portion is at least partially positioned on said one side in the second direction relative to the contact surface.

9. The work machine according to claim 8 wherein the notch portion has a first relief groove portion formed under the contact surface, the first relief groove portion being in a groove shape and open to said one side and downward in the second direction.

10. The work machine according to claim 9 wherein the notch portion has a second relief groove portion, the second relief groove portion being in the groove shape or a hole shape penetrating the fence along the second direction.

11. The work machine according to claim 8,
wherein the notch portion comprises:
a first relief groove portion being in a groove shape and formed under the contact surface and open to said one side and downward in the second direction; and
a second relief groove portion formed at a lower end portion of the fence and penetrating along the second direction,
wherein one-side end portion in the second direction of the second relief groove portion communicates with the first relief groove portion.

12. The work machine according to claim 11 wherein the upper surface of the second relief groove portion, in up-down direction, is positioned flush with or above the upper surface of the first relief groove portion.

13. The work machine according to claim 8,
wherein the base comprises:
a base body to which the fence is fixed; and
a turntable coupled rotatable to the base body with the up-down direction as axis direction,
wherein the dust relief mechanism is disposed opposite the base body.

14. The work machine according to claim 7 wherein the notch portion has a groove portion extending in the first direction, and the groove portion is open at least on said one side or other in the first direction.

15. A work machine comprising:
a base on which a material to be processed is placed on an upper surface;
a main body that is movably connected to the base and drives a blade for cutting the material to be processed; and
a fence extending upward and in first direction from the upper surface of the base,
wherein the base comprises:
a base body to which the fence is fixed; and
a turntable coupled rotatable to the base body with up-down direction as axis direction,
wherein at least one of the fence and the base body has a notch portion extending in the first direction from an end portion thereof in the first direction, and dust on the upper surface of the base can be discharged through the notch portion.
